(19) United States
(12) Patent Application Publication
(10) Pub. No.: US 2012/0125879 A1
(43) Pub. Date: May 24, 2012

(54) METHOD FOR FABRICATING CAPACITOR

(75) Inventors: Jong Kook PARK, Seoul (KR); Han Sang SONG, Seoul (KR)

(73) Assignee: HYNIX SEMICONDUCTOR INC., Icheon-si (KR)

(21) Appl. No.: 13/160,654

(22) Filed: Jun. 15, 2011

(30) Foreign Application Priority Data
Nov. 24, 2010 (KR) 10-2010-0117596

(51) Int. Cl. H01G 13/06

(52) U.S. Cl. 216/6

(57) ABSTRACT

A method for fabricating a capacitor includes: forming a first mold layer having a first through hole on a semiconductor substrate; forming a hole blocking layer filling and blocking an entrance of the first through hole; forming a second mold layer on the hole blocking layer and the first mold layer; forming a second through hole passing through the second mold layer and aligned with the first through hole; selectively removing the hole blocking layer exposed to the second through hole; forming a storage node along a profile of the first and second through holes; and selectively removing a portion of the first and second mold layers.

### CROSS-REFERENCES TO RELATED APPLICATIONS

The present application claims priority under 35 U.S.C 119(a) to Korean Application No. 10-2010-0117596, filed on Nov. 24, 2010, in the Korean intellectual property Office, which is incorporated herein by reference in its entirety.

### BACKGROUND

Exemplary embodiments of the present invention relate to a semiconductor device, and more particularly, to a method for fabricating a capacitor, which can ensure a capacitance of a capacitor by increasing a height of a storage node.

As the integration density of a DRAM device has increased, cylindrical storage node has been adopted to implement a capacitor with relatively higher capacitance in a limited substrate area. An outer wall of a storage node is exposed and a dielectric layer is formed to cover the cylindrical inner and outer walls of the storage node. In this way, the effective surface area of the dielectric layer is increased and capacitance is increased. As the design rule for a semiconductor device is reduced, size of a through hole formed through a mold layer in order to shape a storage node is also reduced. As a result, the aspect ratio of the through hole is increased. Accordingly, it has become difficult to etch the mold layer that would allow the through hole to pass through the mold layer while exposing a storage node contact.

To reduce the aspect ratio of the through hole, it is necessary to either increase the size of the through hole or reduce the thickness of the mold layer through which a through hole is to pass. The reduction in the thickness of the mold layer means reduction in the height of the storage node. When the height of the storage node is reduced, the effective surface area of the dielectric layer is reduced, leading to reduction in capacitance. Therefore, to increase capacitance, the height of the storage node may be increased. To this end, the thickness of the mold layer needs to be increased.

If the thickness of the mold layer is increased, the size of the through hole is greatly reduced by the shrinkage of the design rule and the aspect ratio is further increased. In order to form the through hole, the etch depth of the mold layer is relatively deepened. Consequently, it becomes more difficult to form the through hole passing through the mold layer. Hence, as an aspect ratio increases, it becomes more difficult to effectively etch the mold layer to the bottom, ensure the critical dimension (CD) of the bottom of the through hole to a desired level, and perform an etch process to expose the storage node contact without open failure.

Due to the etch limitation caused by the increase in the aspect ratio of the through hole passing through the mold layer, it is difficult to ensure an open CD at the bottom of the through hole. Thus, it becomes difficult to further increase the thickness of the through hole. As such, since the increase in the thickness of the mold layer reaches a limit due to the etch limitation, increase in the thickness of the storage node is restricted. Therefore, there is a need to develop a method which can further increase the height of the storage node of the capacitor.

### SUMMARY

An embodiment of the present invention relates to a method for fabricating a capacitor of a semiconductor device, which can ensure a large capacitance of a capacitor by increasing a height of a storage node.

In one embodiment, a method for fabricating a capacitor includes: forming a first mold layer having a first through hole on a semiconductor substrate; forming a hole blocking layer filling and blocking an entrance of the first through hole; forming a second mold layer on the hole blocking layer and the first mold layer; forming a second through hole passing through the second mold layer and aligned with the first through hole; selectively removing the hole blocking layer exposed to the second through hole; forming a storage node along a profile of the first and second through holes; and selectively removing a portion of the first and second mold layers.

In another embodiment, a method for fabricating a capacitor includes: forming a first mold layer having a first through hole on a semiconductor substrate; forming a seam inside the first through hole by causing an overhang at an entrance of the first through hole on the first mold layer, and depositing, for example, a titanium nitride (TiN) layer to block the entrance of the first through hole; forming a hole blocking layer by planarizing the titanium nitride (TiN) layer to expose the top surface of the first mold layer; forming a second mold layer on the hole blocking layer and the first mold layer; forming a second through hole passing through the second mold layer and aligned with the first through hole; selectively removing the hole blocking layer exposed to the second through hole; forming a storage node along a profile of the first and second through holes; and selectively removing the first and second mold layers.

In another embodiment, a method for fabricating a capacitor includes: forming a first mold layer having a first through hole on a semiconductor substrate; forming a barrier metal layer on the bottom of the first through hole; forming a seam inside the first through hole by causing an overhang at an entrance of the first through hole on the first mold layer, and depositing, for example, a titanium nitride (TiN) layer to block the entrance of the first through hole; forming a hole blocking layer by planarizing the titanium nitride (TiN) layer to expose the top surface of the first mold layer; forming a second mold layer on the hole blocking layer and the first mold layer; forming a floating fixing layer on the second mold layer; forming a second through hole passing through the floating fixing layer and the second mold layer and aligned with the first through hole; selectively removing the hole blocking layer exposed to the second through hole; forming a storage node along a profile of the first and second through holes; and selectively removing the first and second mold layers.

The method may further include forming a barrier metal layer protecting a surface of the storage node contact exposed to the first through hole.

The method may further include: forming a floating fixing layer, which is to be attached to an upper side of the storage node, on the second mold layer, before forming the second through hole; and exposing a portion of the second mold layer by selectively removing a portion of the floating fixing layer, before selectively removing the first and second mold layers.

The selectively removing of the hole blocking layer may include providing an etch solution, which contains, for example, sulfuric acid (H2SO4) and hydrogen peroxide (H2O2), to the titanium nitride (TiN) layer exposed to the second through hole, and etching the titanium nitride (TiN) layer by penetration of the etch solution into the seam.

### BRIEF DESCRIPTION OF THE DRAWINGS

The above and other aspects, features and other advantages will be more clearly understood from the following detailed description taken in conjunction with the accompanying drawings, in which:

FIGS. 1 to 11 are cross-sectional views illustrating a method for fabricating a capacitor, which increases a height of a storage node, according to an embodiment of the present invention; and

FIG. 12 is a cross-sectional view illustrating a comparative example for explaining the effect of the method for fabricating the capacitor according to the embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

An embodiment of the present invention provides a method which ensures sufficient capacitance by forming a storage node having an increased height within a limited area on a substrate. A process of forming a mold layer and forming a through hole passing through the mold layer is repeated at least twice to increase a height of a storage node. The aspect ratio limitation on a through hole etch process can be overcome by repeating a process of forming a mold layer and then forming a through hole in the mold layer. A storage node is then formed from a through hole formed by connecting successive through holes. In this way a height of a storage node is increased and thus larger capacitance is possible in a smaller substrate area.

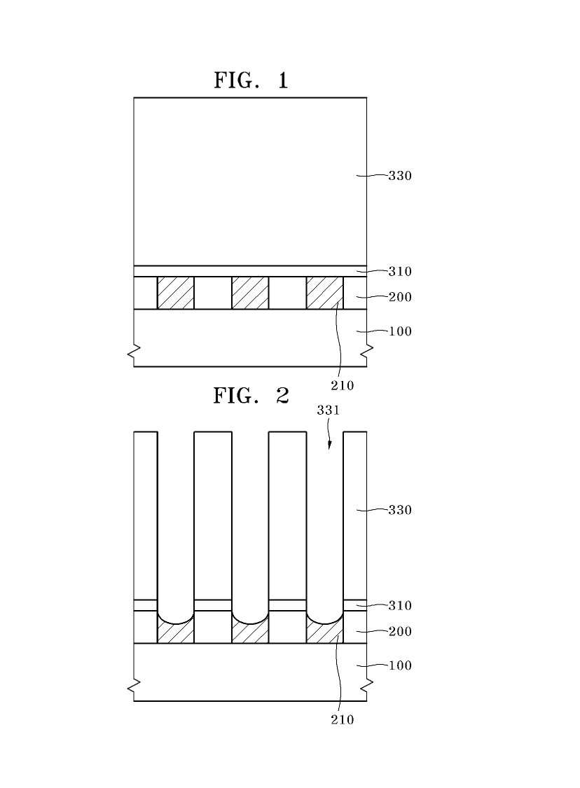

FIG. 1 illustrates a process of forming a cell transistor (not shown) comprising a memory cell of a DRAM on a semiconductor substrate 100. For example, a transistor may be formed in an active region by performing a shallow trench isolation (STI) process on the semiconductor substrate 100. An interlayer dielectric layer 200 covering the transistor is formed as an underlying layer. A connection contact passing through the interlayer dielectric layer 200 is formed as a storage node contact 210. The storage node contact 210 may include, for example, a conductive polysilicon layer doped with impurities, and may be associated with a storage node (for example, the first through hole 331 in FIG. 2).

An etch stop layer 310 is formed on the storage node contact 210, and a first mold layer 330, which may be, for example, a silicon oxide (SiO₂) layer, shaping the storage node is formed as a sacrificial layer. The etch stop layer 310 may be formed to a thickness of, for example, 200 Å to 1,000 Å by using an insulation material such as, for example, silicon nitride (Si₃N₄) with an etch selectivity to the first mold layer 330, so that the etch stop layer 310 serves as an etch stop point in a process of patterning and etching the first mold layer 330.

The etch stop layer 310 may remain in a lower side of the storage node and serve as a support layer supporting the storage node. Before forming the etch stop layer 310, a portion of the interlayer dielectric layer 200 may be recessed to expose a portion of an upper side of the storage node contact 210, and then, the etch stop layer 310 may be formed to cover the upper side of the storage node contact 210. Accordingly, the etch stop layer 310 may reduce penetration of a wet etch solution into an interface between the storage node contact 210 and the interlayer dielectric layer 200 when a wet etch process is used to remove portions of the first mold layer 330. This may substantially reduce loss of the interlayer dielectric layer 200.

When a first through hole shaping the storage node is formed, the first mold layer 330 may be formed in a stacked structure of multilayer insulation layers having different etch rates so that the bottom of the first through hole can be opened even though the first through hole is relatively deep. For example, the first mold layer 330 may be formed in a stacked structure including a phosphorous silicate glass (PSG) layer having a relatively high etch rate and a plasma enhanced tetraethylorthosilicate (PE-TEOS) layer having a relative low etch rate. In some cases, the first mold layer 330 may be formed using a single layer of PSG or TEOS. The thickness of the first mold layer 330 may be set, considering an aspect ratio and size of the first through hole and an etch procedure implementing the first through hole. For example, the first mold layer 330 may be formed in a thickness range from approximately 10,000 Å to approximately 14,000 Å.

Referring to FIG. 2, a first through hole 331 is formed to pass through the first mold layer 330 and expose the storage node contact 210. An etch mask (not shown) is formed on the first mold layer 330 by, for example, a photolithography process, an exposure process, a development process, and an etch process. The first through hole 331 may be formed by dry etching a portion of the first mold layer 330 exposed to the etch mask. The top surface of the storage node contact 210 may be exposed by selectively dry etching a portion of the etch stop layer 310 exposed by the first through hole 331. A portion of the top surface of the storage node contact 210 may be etched by the etch process.

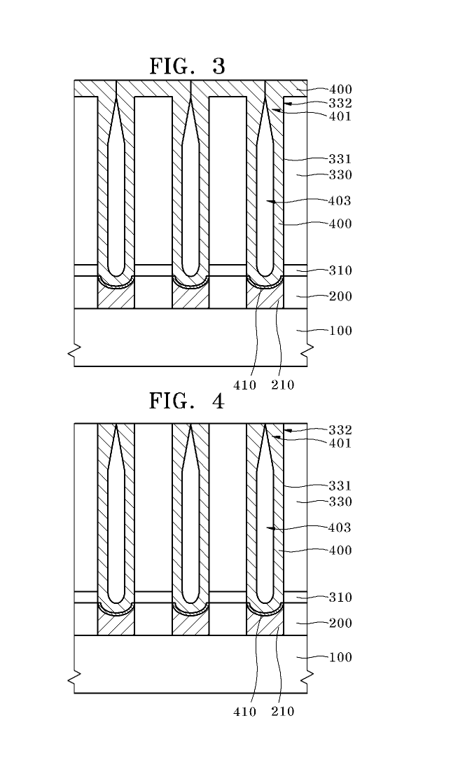

Referring to FIG. 3, a hole blocking layer 400 is formed to fill the first through hole 331. The hole blocking layer 400 blocks the inside of the first through hole 331 to protect the inner sidewall and bottom of the first through hole 331 during a subsequent etch process. The hole blocking layer 400 may be formed of an insulation material having an etch selectivity to an insulation material (e.g., silicon oxide) constituting a second mold layer 350 (FIG. 5). For example, the hole blocking layer 400 may be formed of, for example, silicon nitride or a conductive metallic material, such as titanium nitride (TiN). Since the hole blocking layer 400 may have an etch selectivity to the first mold layer 331, it may be formed of titanium nitride (TiN).

Before the hole blocking layer 400 is formed, a barrier metal layer 410 may be formed on the storage node contact 210 in order to protect the storage node contact 210 and reduce a contact resistance between the storage node and the storage node contact 210 during a subsequent etch process. The barrier metal layer 410 may be formed of, for example, metal silicide such as titanium silicide (TiSiₓ). For example, a titanium (Ti) layer is deposited on the storage node contact 210 exposed to the first through hole 331, and the deposited titanium layer is annealed to induce a silicide reaction between silicon of the storage node contact 210 and titanium. In this way, the titanium layer contacting the surface of the storage node contact 210 at the bottom of the first through hole 331 is changed to titanium silicide to form the barrier metal layer 410. Since the storage node contact 210 is blocked by the barrier metal layer 410, it is possible to effectively suppress the storage node contact 210 from being etched in a subsequent etch process performed on the first through hole 331. The titanium layer may be deposited, for example, by a chemical vapor deposition (CVD) process or a physical vapor deposition (PVD) process.

After the titanium layer is deposited and annealed, a hole blocking layer 400 is formed by depositing titanium nitride (TiN). The titanium nitride may be deposited by a CVD process, or may be deposited while causing an overhang 401 at the entrance 332 of the first through hole 331. As the design rule of the semiconductor device shrinks, substrate area for a capacitor is also reduced. As a result, the first through hole 331 that shapes the storage node of a capacitor is reduced in size, and the overhang 401 is caused in the small entrance 332 during the deposition of titanium nitride. Accordingly, a seam 403, which is an empty space, may be formed within the first through hole 331.

Since the entrance 332 of the first through hole 331 is first blocked by the overhang 401 during the deposition of titanium nitride, the seam 403 is formed within the first through hole 331. In this embodiment, since the hole blocking layer 400 is used as a sacrificial layer which is to be selectively removed in a subsequent process, a total etch amount may be reduced by the seam 403. Thus, the seam 403 is advantageous in a subsequent removal process. Although the titanium nitride layer is provided as the hole blocking layer 400 in this embodiment, another insulation layer or metal layer may be used as the hole blocking layer 400 as long as it has an etch selectivity to the first mold layer 330 or the second mold layer which is to be formed later.

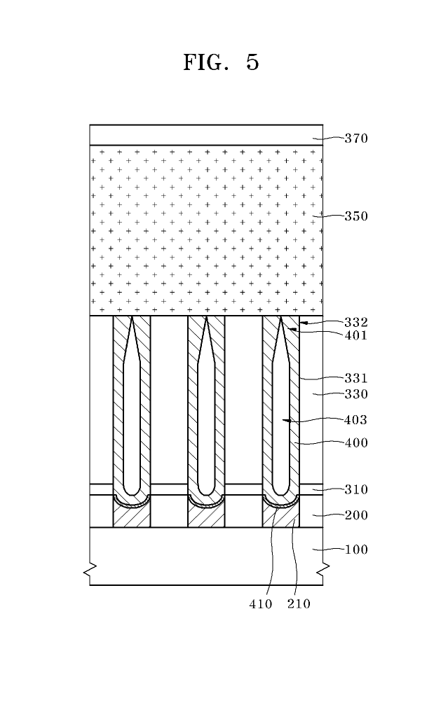

Referring to FIG. 4, the hole blocking layer 400 is planarized to expose the upper surface of the first mold layer 330. Since the overhang 401 of the hole blocking layer 400 still blocks the entrance 332 of the first through hole 331, the profile of the first through hole 331 is protected by the hole blocking layer 400. The planarization process may be performed by an etchback process or a chemical mechanical polishing (CMP) process. Due to the planarization process, the hole blocking layer 400 is divided in units of cells disposed within each first through hole 331.

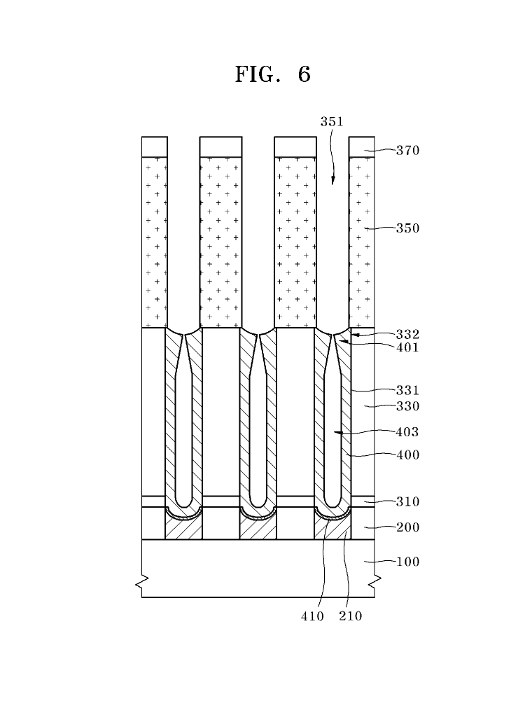

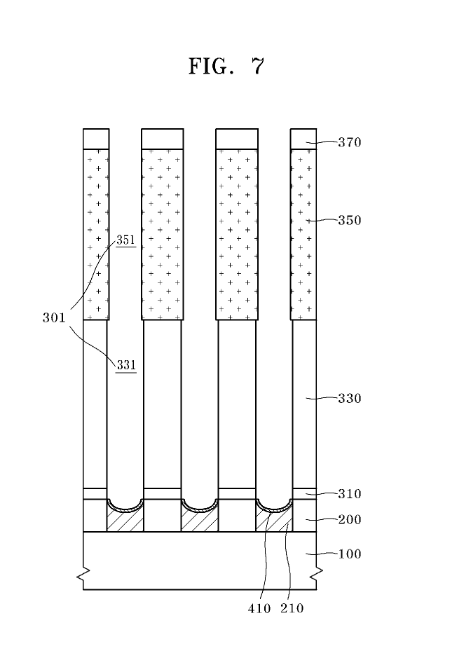

Referring to FIG. 5, a second mold layer 350 is formed on the first mold layer 330 exposed by the planarization of the hole blocking layer 400. Since the hole blocking layer 400 and the first mold layer 330 have flat underlayer structure, the second mold layer 350 may be formed to have a flat and uniform thickness. The second mold layer 350 may include an insulation layer which is substantially identical to the first mold layer 330. When a second through hole 351 (FIG. 6) is formed, the second mold layer 350 may be formed in a stacked structure of multilayer insulation layers having different etch rates so that the bottom of the second through hole 351 can be opened even though the second through hole 351 may be relatively deep.

For example, the second mold layer 350 may be formed in a stacked structure including a PSG layer having a relatively high etch rate and a PE-TEOS layer having a relative low etch rate. In some cases, the second mold layer 350 may be formed using a single layer of PSG or TEOS. The thickness of the second mold layer 350 may be set, for example, considering an aspect ratio and size of the second through hole and an etch procedure for the second through hole. The second mold layer 350 may be formed in a thickness range from approximately 10,000 Å to approximately 14,000 Å.

A floating fixing layer 370 is formed on the second mold layer 350 to prevent the storage nodes from falling or leaning by fixing the upper side of the storage nodes. The floating fixing layer 370 may be formed using an insulation layer having an etch selectivity to the second mold layer 350 such as, for example, a silicon nitride (Si₃N₄) layer.

Referring to FIG. 6, a second through hole 351 is formed to pass through the floating fixing layer 370 and the second mold layer 350 and align with the first through hole 331. An etch mask (not shown) is formed on the floating fixing layer 370, and a portion of the floating fixing layer 370 exposed by the etch mask is selectively dry etched. An exposed portion of the second through hole 370 is selectively etched to form the second through hole 351. The etch process is performed to expose the hole blocking layer 400 to the bottom of the second through hole 351. However, since the inner sidewall and bottom of the first through hole 331 is blocked and protected by the hole blocking layer 400, the profile of the first through hole 331 can be protected and maintained, without being damaged during the etch process. The hole blocking layer 400 may be partially recessed during the etch process so that the seam 403 may be exposed.

Referring to FIG. 7, the hole blocking layer 400 exposed to the second through hole 351 is selectively removed to expose the sidewall and bottom of the first through hole 331. Accordingly, the second through hole 351 and the first through hole 331 define a through hole 301. As such, by repeating the process of depositing the mold layers 330 and 350 and etching the through holes, a total thickness of the mold layers 330 and 350 is increased beyond a critical level of the through hole etching. Therefore, the through hole 301 can be formed deeper than if it was to be formed as a single through hole. Accordingly, it is possible to increase the height of a storage node beyond the height of each of the individual mold layers 330 and 350. As a result, it is possible to secure a larger capacitance of a capacitor.

In case the hole blocking layer 400 is formed using titanium nitride, a wet etch process is performed using a sulfuric acid peroxide mixture (SPM) containing sulfuric acid (H₂SO₄) and hydrogen peroxide (H₂O₂) having an etch selectivity to the first and second mold layers 330 and 350, in order to etch the hole blocking layer 400. The etch solution is introduced into a seam 403 and is in contact with the sidewall and bottom of the hole blocking layer 400. Then, a wet etch process is performed. Accordingly, the hole blocking layer 400 is selectively removed to expose the sidewall of the first through hole 331. Since the storage node contact 210 under the bottom of the first through hole 331 is blocked and protected by the barrier metal layer 410, it is not protected without being exposed to the wet etch solution. Hence, it is possible to suppress the etch loss caused by the wet etch solution.

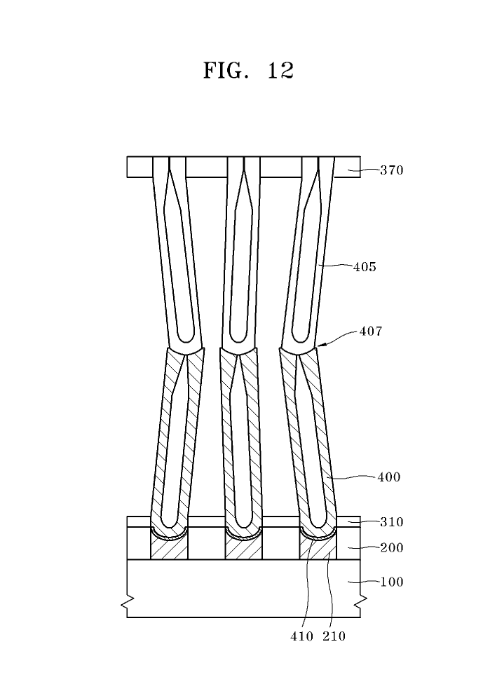

As illustrated in FIG. 12, it is possible to consider a process of directly depositing a conductive layer 405 for a storage node on the hole blocking layer 400, without removing the hole blocking layer 400. In this case, however, after the deposition of the conductive layer 405, bending phenomenon frequently occurs at the junction interface 407 between the conductive layer 405 and the hole blocking layer 400 during a wet etch process of selectively removing the first and second mold layers 330 and 350. Such a bending phenomenon is a result of an adhesive force present at the junction interface 407 between the conductive layer 405. The hole blocking layer 400 is vulnerable relative to the surface tension created during the wet etch process of removing the first and second mold layers 330 and 350 and the subsequent dry process. In order to prevent such a bending phenomenon, the hole blocking layer 400 is removed as described with respect to FIG. 7 to thereby form the through hole 301 in which the first and second through holes 331 and 351 are connected together.

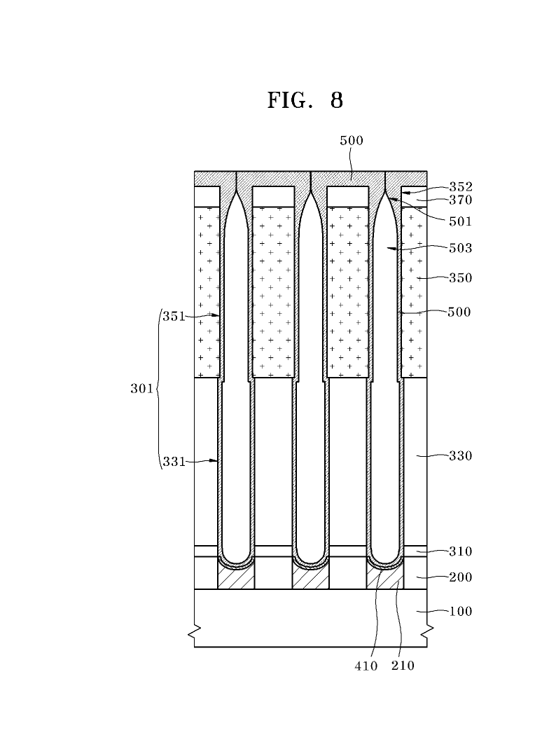

Referring to FIG. 8, a storage node layer 500 is deposited in the through hole 301. By a CVD of titanium nitride (TiN), the storage node layer 500 is formed to extend to cover the barrier metal layer 410 under the bottom of the first through hole 331 and cover the sidewalls of the first through hole 331 and the second through hole 351. An overhanging edge may be formed at a portion of the through hole 301 where the first and second holes 331 and 351 are joined, because of the smaller size of the second through hole 351 at the entrance 352 of the second through hole 351.

As the design rule of the semiconductor device shrinks, the second through hole 351 is reduced in size. As a result, an overhang 501 is formed at the small entrance 352 during the deposition of titanium nitride, thereby defining a seam 503, which is an empty space, within the second through hole 351 and the first through hole 331. Since the entrance 352 of the second through hole 351 is first blocked by the overhang 501 during the deposition of titanium nitride, the seam 503 is formed within the storage node layer 500. The storage node layer 500 may be deposited with a high conformality without causing the seam 503. However, since the size of the through hole 301 is small and the aspect ratio is very large, it is difficult to form the storage node layer 500 to fully fill the inside of the through hole 301 without causing the overhang 501. Accordingly, the nodes are separated by planarizing the storage node layer 500. In this way, the storage node can be formed in a pillar shape without exposing the seam 503.

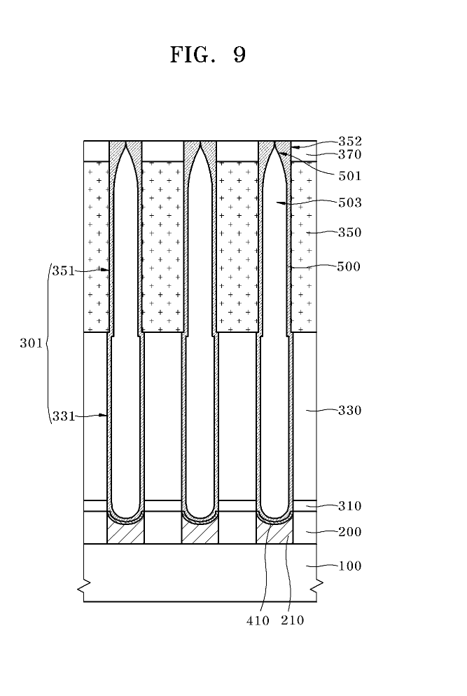

Referring to FIG. 9, the storage node layer 500 is planarized to expose the top surface of the floating fixing layer 370. In this way, the nodes are separated so that the storage node 500 is located within the through hole 301. Although the planarization process may be performed by an etchback process or a CMP process, the CMP process may be more suitable for uniform node separation. After the planarization, the overhang 501 of the storage node 500 still blocks the entrance 352 of the second through hole 351. Thus, the storage node 500 is formed in a pillar shape with the seam 503. The storage node can be formed in a cylinder shape by selectively etching the overhang 501 to expose the seam 503. However, since a concave portion of the cylinder is very narrow, it may be difficult for a dielectric layer and a plate node layer to fill the concave portion of the cylinder in a subsequent process. Accordingly, the overhang 501 is maintained to make the storage node 500 have a pillar shape, and a dielectric layer and a plate node layer are formed on an outer wall of the pillar-shaped storage node 500. In this way, a capacitor is formed.

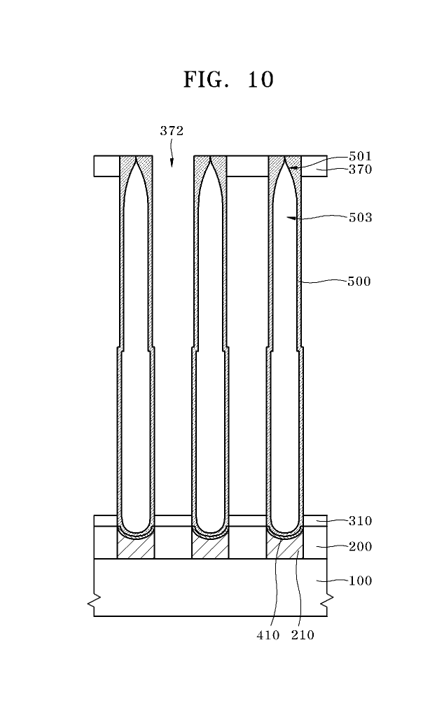

Referring to FIG. 10, a portion of the floating fixing layer 370 is selectively removed to form an opening hole 372 exposing the second mold layer 350. The second mold layer 350 is then removed by a wet etching process. An oxide etch solution such as, for example, BOE contacts the second mold layer 350 through the opening hole 372 and wet etches the second mold layer 350. The oxide etch solution continues to flow and wet etches the first mold layer 330. The opening hole 372 is used as a passage for a wet etch. The opening hole 372 may be used as a passage through which a deposition source flows during a subsequent deposition of a dielectric layer and a plate node layer. The second mold layer 350 and the first mold layer 330 are sequentially wet etched to expose an outer wall of the storage node 500. Unlike the case of FIG. 12, the storage node 500 has no junction interface (407 in FIG. 12) of layers. Thus, the storage node 500 can be more resistant to stress caused by a surface tension during the wet etch process and a subsequent dry process. Since the storage node 500 is continuous, the junction interface 407 is not formed. Accordingly, there is no bending phenomenon in this structure.

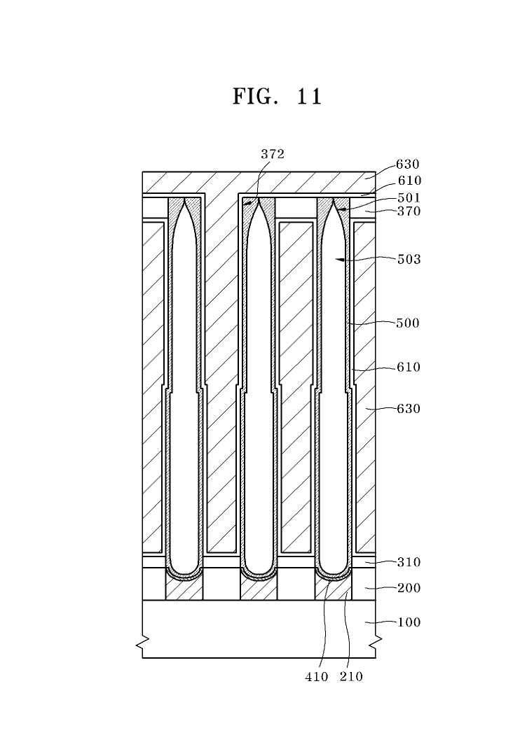

Referring to FIG. 11, a deposition source is introduced through the opening hole 372, and a dielectric layer 610 is formed at an outer wall of the storage node 500. A plate node 630 is formed by depositing a conductive layer on the dielectric layer 610. Accordingly, the storage node 500 has a pillar shape, and the capacitance of the capacitor is increased by the increased height of the storage node 500. The dielectric layer 610 may be formed by depositing a high dielectric constant (high-k) material, and the plate node 630 may be formed using a metal layer, such as, for example, a noble metal, a conductive polysilicon layer, or a combination thereof.

According to various embodiments of the present invention, when the through hole shaping the storage node is formed to pass through the mold layer, the storage node of the capacitor can be formed to have a larger height than the thickness of a single mold layer. Since the height of the storage node can be increased, the effective surface area of the dielectric layer can be increased. Therefore, a large capacitance of a capacitor can be ensured within a limited surface area of a substrate.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A method for fabricating a capacitor, comprising:
forming a first mold layer having a first through hole on a semiconductor substrate;
forming a hole blocking layer filling and blocking an entrance of the first through hole;
forming a second mold layer on the hole blocking layer and the first mold layer;
forming a second through hole passing through the second mold layer and aligned with the first through hole;
selectively removing the hole blocking layer exposed to the second through hole;
forming a storage node along a profile of the first and second through holes; and
selectively removing a portion of the first and second mold layers.

2. The method of claim 1, further comprising:
forming an interlayer dielectric layer between the first mold layer and the semiconductor substrate;
forming a storage node contact passing through the interlayer dielectric layer and aligned with the first through hole; and
forming an etch stop layer at an interface between the interlayer dielectric layer and the first mold layer.

3. The method of claim 2, wherein the first mold layer is formed using an insulation layer comprising at least one of a phosphorous silicate glass (PSG) layer and a tetraethylorthosilicate (TEOS) layer.

4. The method of claim 3, wherein the second mold layer is formed using an insulation layer which is substantially identical to the insulation layer constituting the first mold layer.

5. The method of claim 2, further comprising forming a barrier metal layer protecting a surface of the storage node contact exposed to the first through hole.

6. The method of claim 5, wherein the barrier metal layer comprises a metal silicide.

7. The method of claim 2, wherein the storage node contact comprises a conductive polysilicon layer, and the forming of the barrier metal layer comprises:
depositing a titanium (Ti) layer contacting the polysilicon layer exposed to the bottom of the first through hole; and
forming a titanium silicide (TiSiₓ) layer covering the top surface of the storage node contact by annealing the titanium (Ti) layer.

8. The method of claim 1, further comprising:
forming a floating fixing layer, which is to be attached to an upper side of the storage node, on the second mold layer, before forming the second through hole; and
exposing a portion of the second mold layer by selectively removing a portion of the floating fixing layer, before selectively removing a portions the first and second mold layers.

9. The method of claim 1, wherein the hole blocking layer comprises at least one of an insulation layer and a metal layer having an etch selectivity to the first mold layer.

10. The method of claim 1, wherein the forming of the hole blocking layer comprises:
forming a seam inside the first through hole by causing an overhang at an entrance of the first through hole on the first mold layer, and depositing the hole blocking layer to block the entrance of the first through hole; and
planarizing the hole blocking layer to expose the top surface of the first mold layer.

11. The method of claim 1, wherein the forming of the hole blocking layer comprises:
forming a seam inside the first through hole by causing an overhang at an entrance of the first through hole on the first mold layer, and depositing a titanium nitride (TiN) layer to block the entrance of the first through hole; and
planarizing the titanium nitride (TiN) layer to expose the top surface of the first mold layer.

12. The method of claim 11, further comprising forming a barrier metal layer contacting the bottom of the first through hole, before depositing the titanium nitride (TiN) layer.

13. The method of claim 12, wherein the forming of the barrier metal layer comprises:
depositing a titanium (Ti) layer; and
annealing the titanium (Ti) layer to transform the titanium (Ti) layer contacting the bottom of the first through hole into a titanium silicide.

14. The method of claim 11, wherein the selectively removing of the hole blocking layer comprises:
providing an etch solution, which contains sulfuric acid (H₂SO₄) and hydrogen peroxide (H₂O₂), to the titanium nitride (TiN) layer exposed to the second through hole.

15. The method of claim 1, wherein the forming of the storage node comprises:
forming seams inside the second through hole and the first through hole by causing an overhang at an entrance of the second through hole on the second mold layer, and depositing a titanium nitride (TiN) layer to block the entrance of the second through hole; and
forming a pillar having a seam by planarizing the titanium nitride (TiN) layer to expose the top surface of the second mold layer.

16. A method for fabricating a capacitor, comprising:
forming a first mold layer having a first through hole on a semiconductor substrate;
forming a seam inside the first through hole by causing an overhang at an entrance of the first through hole on the first mold layer, and depositing a titanium nitride (TiN) layer to block the entrance of the first through hole;
forming a hole blocking layer by planarizing the titanium nitride (TiN) layer to expose the top surface of the first mold layer;
forming a second mold layer on the hole blocking layer and the first mold layer;
forming a second through hole passing through the second mold layer and aligned with the first through hole;
selectively removing the hole blocking layer exposed to the second through hole;
forming a storage node along a profile of the first and second through holes; and
selectively removing the first and second mold layers.

17. The method of claim 16, wherein the method further comprises:
forming an interlayer dielectric layer between the first mold layer and the semiconductor substrate; and
forming a storage node contact passing through the interlayer dielectric layer and aligned with the first through hole, and
the method further comprises, before depositing the titanium nitride (TiN) layer:
depositing a titanium (Ti) layer contacting the storage node contact exposed to the bottom of the first through hole; and
annealing the titanium (Ti) layer to form a titanium silicide (TiSiₓ) layer protecting the storage node contact when the hole blocking layer is removed.

18. A method for fabricating a capacitor, comprising:
forming a first mold layer having a first through hole on a semiconductor substrate;
forming a barrier metal layer on the bottom of the first through hole;
forming a seam inside the first through hole by causing an overhang at an entrance of the first through hole on the first mold layer, and depositing a titanium nitride (TiN) layer to block the entrance of the first through hole;
forming a hole blocking layer by planarizing the titanium nitride (TiN) layer to expose the top surface of the first mold layer;
forming a second mold layer on the hole blocking layer and the first mold layer;
forming a floating fixing layer on the second mold layer;
forming a second through hole passing through the floating fixing layer and the second mold layer and aligned with the first through hole;
selectively removing the hole blocking layer exposed to the second through hole;
forming a storage node along a profile of the first and second through holes; and
selectively removing the first and second mold layers.

19. The method of claim 18, further comprising:
forming an interlayer dielectric layer between the first mold layer and the semiconductor substrate; and
forming a storage node contact which passes through the interlayer dielectric layer, is aligned with the first through hole, and protects the top surface of the barrier metal layer when the hole blocking layer is removed.

20. The method of claim 18, wherein the selectively removing of the first and second mold layers comprises:
exposing a portion of the second mold layer by selectively removing a portion of the floating fixing layer; and
sequentially removing the second mold layer and the first mold layer from the exposed portion of the second mold layer.
